(19) United States
(12) Patent Application Publication
(10) Pub. No.: US 2010/0269414 A1
(43) Pub. Date: Oct. 28, 2010

(54) GRAPHIC DESIGN LAMINATE FOR GARAGE DOORS

(75) Inventor: BRYAN W. HORTON, Ft. Wright, KY (US)

Correspondence Address: BAKER & DANIELS LLP, 300 NORTH MERIDIAN STREET, SUITE 2700, INDIANAPOLIS, IN, 46204, US

(73) Assignee: ECP Safe-Way, LLC, Warsaw, IN (US)

(21) Appl. No.: 12/428,867

(22) Filed: Apr. 23, 2009

(51) Int. Cl. E05D 15/38; E06B 9/00; E06B 3/00; B23P 17/04

(52) U.S. Cl. 49/197; 160/130; 49/506; 29/428

(57) ABSTRACT

Graphic design panels of the present invention include flexible material with “life-like” images printed thereon that decorate a sectional overhead garage door with a plurality of graphic design panels. The graphic design panels are affixed to the garage door so that a complete image of an object or of scenery is provided. The image selected for displaying on a sectional overhead garage door is divided into a plurality of sections and printed accordingly onto the flexible laminar substrate panels. The flexible laminar substrate panel is a polymeric material, for example, vinyl, and is impregnated with an adhesive on at least one face of the panel. “Life like” images are produced on the graphic design substrate panel by screen printing methods and the printed surface is protected by a graphic protection film.

### FIELD OF THE INVENTION

The invention relates to graphic designs for exterior surfaces. The invention more particularly relates to preparing graphic designs for sectional overhead garage doors.

### BACKGROUND

A number of methods are used to decorate exterior walls comprising a plurality of sections, for example, a sectional overhead garage door comprising of a plurality of horizontal sections. Decorative wooden panels are affixed to the sections of garage doors for decorative purposes; however, wooden panels are often heavy and bulky. Lighter wooden panels, for example, lighter plywood panels are sometimes used; however, such lighter plywood panels are not sturdy and readily deteriorate upon exposure to environmental elements. In addition to being heavy and fragile, wooden panels are also expensive, making their use highly undesirable.

Alternately, panels or sheets comprising other materials, for example, synthetic polymers such as polyethylene, polyurethane, vinyl, plastic, fiber glass or metals such as aluminum, are used for decorating garage doors. Decorative panels made from synthetic polymers are prone to mechanical damage and breakage; whereas, metal panels are heavy.

For seasonal decorations, for example, during Halloween or Christmas, sheets of flexible and elastic materials with decorative images thereon are stretched across the entire garage door. These flexible, elastic sheets may be easily removed when desired; however, applying these sheets tightly over garage doors produces wrinkles on its surface that hampers its appearance and decorative properties. Further, repeated opening and closing of the garage door causes these covers to lose their flexibility, and such covers often tear off with longer use.

Therefore, there is a need in the art for decorative fabrications for garage doors that are light, inexpensive, able to withstand environmental elements, mechanically sturdy and not compromising on its appearance or decorative properties.

### SUMMARY OF THE INVENTION

The invention provides a sectional overhead garage door comprised of a plurality of horizontal sections, onto which are affixed a plurality of flexible laminar substrate panels with a graphic design thereon, wherein, affixing the plurality of the flexible laminar substrate panels onto the sections of the garage door produces an image of an object or a natural scene on the garage door, or other exterior surface of a building. The invention provides flexible laminar substrate panels with graphic design thereon which may be affixed to an exterior building surface.

An aspect of the invention provides flexible laminar substrate panels comprised of vinyl wherein graphic designs are screen printed thereon to provide “life like” appearance to the image displayed on the surface to be decorated.

In a further aspect of the invention the screen printed surface of the flexible laminar substrate is covered with a graphic protection material which protects the printed graphic design from damage or disfiguration.

An aspect of the invention involves using an adhesive to affix the flexible laminar substrate panel to a substantially flat surface. In an even further aspect of the invention a pressure-sensitive adhesive is applied the flexible laminar substrate panels. An even further aspect of the invention involves affixing the graphic design panels onto the surface to be decorated, with affixing mechanisms of the mechanical type.

A further aspect of the invention involves printing the graphic designs directly on the sections of surface to be decorated, for example, horizontal sections of a garage door.

An aspect of the invention provides a kit comprised of a plurality of flexible laminar substrate panels with a graphic design thereon wherein, the plurality of flexible laminar substrate panels are customized for decorating a particular surface. In an aspect of the invention, an image displayed on a substantially flat surface comprising of a plurality of sections is specifically selected, for example, a “Carriage House” design. In a further aspect of the invention, the number, orientation, size and dimensions of the panels of the plurality of flexible laminar substrate panels are customized for decorating a particular surface.

A further aspect of the invention provides a method of making a kit comprising a plurality of flexible laminar substrate panels with a portion of a graphic design thereon, wherein, upon affixing the plurality of the panels onto a substantially flat surface, a complete graphic design is produced on the substantially flat surface.

Current methodologies for the application of decorative laminates onto a garage door surface involves the manual application of coated, printed (e.g., decorative design, photograph, logo) Vinyl stock upon a garage door surface. The laminate may be applied manually with a self correcting adhesive on the reverse side of the Vinyl print stock. The self correcting adhesive may be a standard pressure sensitive adhesive (PSA) with micro-spherical glass beads to adjust or level to a textured coil metal stock surface. Advantageously, the laminate may be applied in a rotary pattern onto a metal garage surface with no further need for self leveling PSA. The vinyl chemistry type surface is ‘honeycombed’ at the reverse (adhesive side) and conventional PSA is encapsulated within the honeycombs and activated by heat during the rotary lamination process

### BRIEF DESCRIPTION OF THE FIGURES

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is an exemplary sectional overhead garage door decorated with a plurality of flexible laminar substrate panels with graphics designs printed thereon providing a “carriage house door” appearance.

FIG. 2-A represents an embodiment of the current invention comprising, decorating a sectional overhead garage door having a plurality of horizontal sections by affixing a plurality of flexible laminar substrate panels with a portion of graphic designs printed thereon.

FIG. 2-B is a side sectional view of the flexible laminar substrate panel with an optional graphic protection layer.

FIG. 3 is a schematic representation of the process of decorating a substantially flat exterior surface according to the aspect of the current invention.

FIG. 4 represents an embodiment of the current invention showing a front view of decorating a substantially flat surface with laminar substrates wherein the adjacent panels contain a gap in-between.

FIG. 5A represents an embodiment of the current invention showing a side sectional view of decorating a substantially flat surface with laminar substrate wherein the adjacent panels contain gaps in between, and the gap is covered by extensions from multiple coverings.

FIG. 5B represents an embodiment of the current invention showing a side sectional view of decorating a substantially flat surface with laminar substrate wherein the adjacent panels contain gaps in between, and the gap is covered by single covering.

FIG. 6 represents an embodiment of the current invention showing a substantially flat surface wherein a panel overlaps over the adjacent panels

FIG. 7 is a schematic representational view of modifications of the substantially flat surface.

Although the drawings represent embodiments of the present invention, the drawings are not necessarily to scale and certain features may be exaggerated in order to better illustrate and explain the present invention. Although the exemplification kit out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

The embodiments hereinafter disclosed are not intended to be exhaustive or limit the invention to the precise forms disclosed in the following description. Rather the embodiments are chosen and described so that others skilled in the art may utilize its teachings.

The invention relates to a method for decorating a building surface. In an aspect of the invention a substantially flat surface is an interior surface of a building, for example, a house or a shop. In an additional aspect of the invention, the substantially flat surface is an exterior surface of a dwelling, for example, the outer surface of a garage door, or a fence. In a further aspect of the invention, the substantially flat surface is exposed to the environmental elements, for example, rain, extreme temperatures during winter and summer, snow, sunshine or dust.

In one aspect of the invention, the surface is comprised of a plurality of sections. In another aspect of the invention, the surface is substantially flat, for example a garage door comprising a plurality of sections. In an even further aspect of the invention the garage door is a sectional overhead garage door. In a further aspect of the invention, the sectional overhead garage door is comprised of the plurality of horizontal sections that are movably connected to each other. In an even further aspect of the invention, the opening and closing of the sectional overhead garage door is facilitated by rollers.

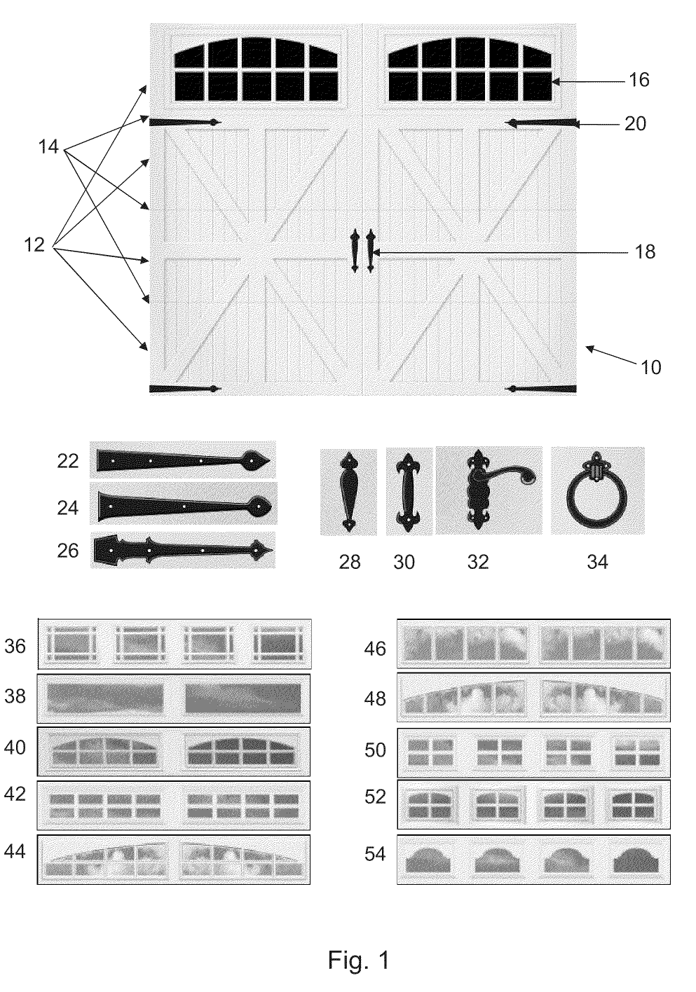

In an aspect of the invention the substantially flat surface is decorated with an image of an object or a scene. FIG. 1 shows a particular embodiment of the invention, wherein a “Carriage House” design is displayed on the surface to be decorated. Carriage House design is specifically selected because of its particularly pleasing and aesthetic appearance. In FIG. 1, the applicants describe sectional overhead garage door 10 comprised of a plurality of horizontal sections 12 onto which are affixed a plurality of flexible laminar substrate panels with a portion of a Carriage House Design printed thereon. Lines 14 represent the breaks between the plurality of horizontal sections.

The image of the Carriage House door further comprises several sub-images, for example hinges 18 and handles 20. Strap hinge 22, Hammered Iron 24 and Heritage hinge 26 represent the non-limiting examples of hinges. Steel handle 28, Hammered Iron handle 30, Carriage handle 32, and Carriage knocker kit 34 represent further non-limiting examples of handle images.

The image of the carriage door further includes windows 16. Prairie 36, Plain windows 38, Stockton arch 40, Stockton long 42, Somerton 44, Stockbridge 46, Wyndbridge 48, Stockton 50, Cascade 52, and Cathedral 54 represent the non-limiting examples of different designs of windows. It is expensive to install windows in a garage door, such as those installed in a conventional “Carriage House” design. Affixing on garage doors, flexible laminar substrate panels having an image thereon that depict the windows of a “Carriage House,” provides “the Carriage House window look” at much reduced expense. Further, not having actual windows on garage doors provides additional security for the garage door.

The embodiments of the current invention depicted in FIG. 1 are only exemplary of the current invention and are not intended to limit the scope of the current invention in any way. A skilled artisan may easily envision, the current invention may be applied to provide other embodiments, for example, additional graphic designs or other surfaces to be decorated.

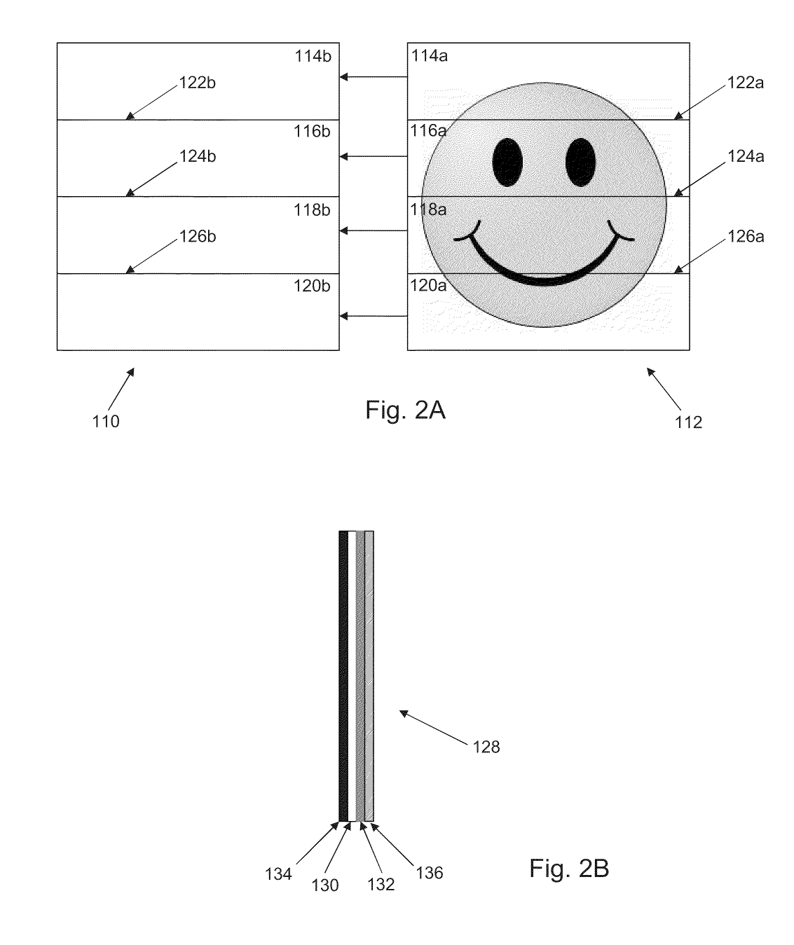

An aspect of the invention depicted in FIG. 2A provides a plurality of flexible laminar substrate panels 114a, 116a, 118a and 120a with a portion of image 112 of an object or scenery printed thereon, wherein, affixing the plurality of the panels onto the plurality of sections 114b, 116b, 118b and 120b of surface to be decorated 110, produces a complete image of the object or a natural scene on surface 110. Lines 122a, 124a and 126a in image 112 correspond to separations 122, 124, and 126 between the plurality of sections.

FIG. 2B represents an embodiment of the current invention showing a flexible laminar substrate panel. Flexible laminar substrate panel 128 comprises flexible substrate sheet 130 with printing material 132 printed thereon. Flexible laminar substrate 128 further comprises adhesive 134 and graphic design protection layer 136.

The flexible laminar substrate panels of the current invention are substantially thin and flexible, for example, the flexible laminar substrate panels of the current invention may be easily folded or rolled. Further, the flexible laminar substrate panels are composed of substrate material that imparts flexibility, elasticity and plasticity to the panels. In an aspect of the invention, the flexible laminar substrate panels are comprised of a synthetic polymer substrate. In an even further aspect of the invention the flexible laminar substrate panels are comprised of vinyl, polycarbonate, polyethylene, polystyrene or other flexible polymeric substrate.

In a further embodiment of the invention, the flexible laminar substrate panels are approximately 0.1-10 mils thick. In an additional embodiment of the current invention, the flexible laminar substrate panels are 0.1 to 6 mil thick. In a further embodiment of the invention, the flexible laminar substrate panels are approximately 0.5-5 mil thick. In an even further embodiment of the invention, the flexible laminar substrate panels are 1-4 mil thick. In an even further embodiment of the invention, the flexible laminar substrate panels are 2-3 mil thick. In an even further embodiment of the invention, the flexible laminar substrate panels are 2 mil thick.

An aspect of the invention comprises printing the image on the flexible laminar substrate panels. In a further aspect of the invention, the image is screen-printed onto the flexible laminar substrate panels. In an even further aspect of the invention, the image printed onto the flexible laminar substrate panel provides “life like” appearance to the image produced onto the surface to be decorated.

In an aspect of the invention a graphic protection layer covers the side of the flexible laminar substrate panel onto which the portion of a graphic design is printed. In a further aspect of the invention, affixing the graphic protection layer onto the printed surface of the flexible laminar substrate panel does not disfigure or damage the image printed onto the panel. In an aspect of the invention, the graphic design protection layer is transparent. In a further aspect of the invention, the graphic design protection layer is colored. In an even further aspect of the invention, the graphic design protection layer is opaque.

In an additional embodiment of the invention, the flexible laminar substrate panel is covered by an adhesive on at least one side. In a further embodiment of the invention, the adhesive used to cover the substrate is a pressure sensitive adhesive. Using a pressure sensitive adhesive allows sliding and repositioning of the flexible laminar substrate panel over the surface to be decorated. Once a flexible laminar substrate is properly positioned, the pressure sensitive adhesive may be activated by applying pressure onto the substrate thereby affixing the panel on the surface to be decorated.

In an additional embodiment of the invention, the flexible laminar substrate panels contain an adhesive on at least one side and further the flexible laminar substrate has air release channels. Air release channels help in air-bubble free installations of the flexible laminar substrate panels. An “air bubble free installation” refers to affixing of the flexible laminar substrate panels on a substantially flat surface wherein essentially no air is trapped between the surface to be decorated and the panels affixed thereon.

In an additional embodiment of the invention, the adhesive does not cover the entire surface of the flexible laminar substrate panel, for example, the adhesive is only present in patches distributed all over the surface of the flexible laminar substrate panels. Such an arrangement of adhesive saves the cost of manufacturing by reducing the amount of adhesive required, and makes it easy to affix the flexible laminar substrate panel onto the surface to be decorated and also simplifies the removal of the flexible laminar substrate panels from the surface.

In a particular embodiment of the invention, flexible laminar substrate panels are easy to remove from the surface to which the panels are affixed. For example, impregnating the flexible laminar substrate panel with non-stick glue facilitates easy removal of the panels without leaving the residue of the adhesive on the surface decorated therewith. Alternately, the flexible laminar substrate panels may comprise of paramagnetic or ferromagnetic material and the surface to be decorated may comprise of a magnetic material, or vice-versa, so that the flexible laminar substrate panels may be easily removed from the surface decorated therewith. In an even further aspect of the invention, the flexible laminar substrate panels are affixed onto the sections of the surface to be decorated by employing an electric field in-between the panels and the surface to be decorated. Removing the electric field in-between the panels and the surface allows for an easy removal of the flexible laminar substrate panels from the surface. Easy removal of the flexible laminar substrate panels allows easy changing the image used for decorating the surface.

In a particular embodiment of the invention the graphic design panels are affixed to the surface to be decorated by mechanisms other than impregnating the flexible laminar substrate panels with adhesives. In an embodiment of the invention, the flexible laminar substrate panels may be affixed to the surface to be decorated by adhesive tapes. In a further aspect of the invention, the laminar substrate panels are affixed to the surface to be decorated with an adhesive tape which contains an adhesive material on both of its surfaces thereby sticking to the surface to be decorated on the one side and to the flexible laminar substrate panel on the other side. In a further embodiment of the invention, the flexible laminar substrate panels are affixed to the surface to be decorated with nails and/or other mechanical mechanisms.

In an additional embodiment of the invention, the flexible laminar substrate panels provide the functions of receiving printing material and also attaching to the surface to be decorated. Additionally, the graphic design panels may be comprised of a flexible material that allows printing and deposition of the adhesive material on the same side of the panel which will help to protect the printed graphic from environmental elements and may also negate the need for the graphic protection films.

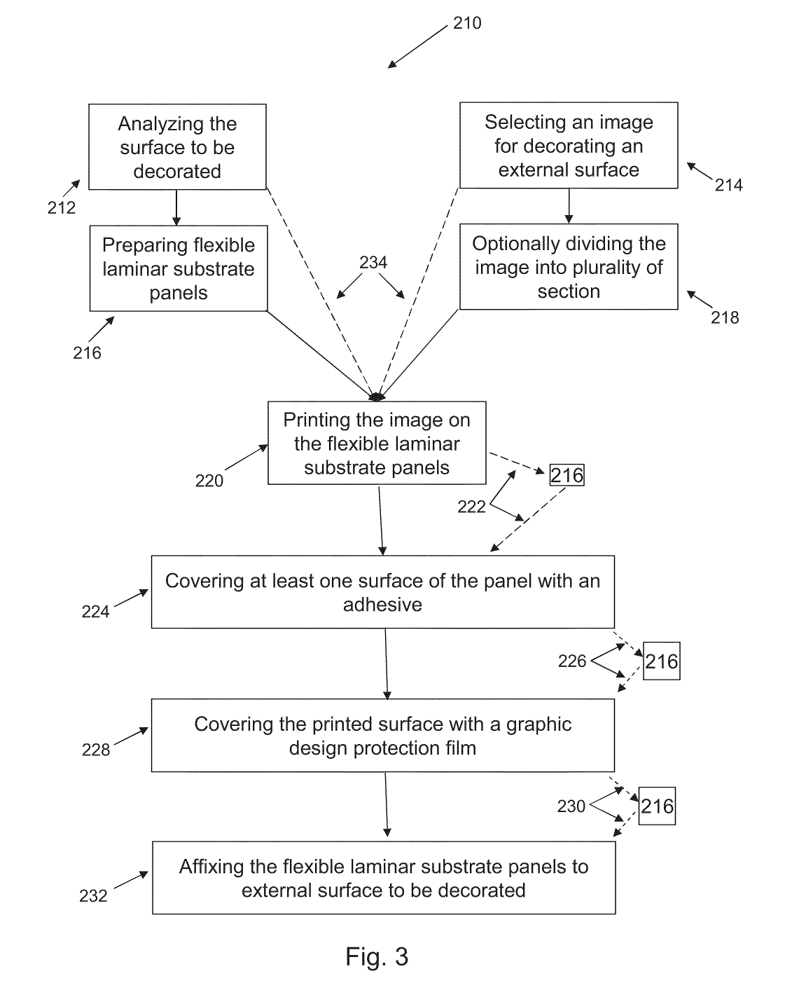

FIG. 3A depicts an aspect of the invention which provides a method of making kit 210 for decorating a substantially flat surface with plurality of sections. The method of according to one embodiment of the current invention provides a method of making a kit comprised of a plurality of flexible laminar substrate panels with graphic design thereon, wherein affixing the panels onto a substantially flat surface comprised of a plurality of sections produces an image of an object or a natural scene onto the surface. The method of according to the current invention provides a method of making a kit comprised of a plurality of flexible laminar substrate panels with graphic design thereon, wherein affixing the panels onto a substantially flat surface comprised of a plurality of sections produces an image, such as of the “Carriage House” onto the surface.

In an aspect of the invention, the method of producing the kit is comprised of selecting image 214 and analyzing a particular surface to be decorated 212. Specifically, the number, orientation, shapes and dimensions of the plurality of sections of the surface to be decorated are analyzed. In a further aspect of the invention, a plurality of flexible laminar substrate panels are prepared wherein the number, orientation, shapes and dimensions of the flexible laminar substrate panels correspond to the number, orientation, shapes and dimensions of the plurality of sections of the surface to be decorated 216.

In an aspect of the invention, the image to be displayed on the surface to be decorated is specifically selected, for example, by a customer. In a further aspect of the invention, the image to be displayed on the surface to be decorated is manipulated 218, for example, using a computer software program for editing an image. In an even further aspect of the invention, the image is divided into a plurality of sections corresponding to the number, orientation, shapes and dimensions of the plurality flexible laminar substrate panels and the sections of the surface to be decorated.

In an additional embodiment of the invention, the selected image is printed onto a single laminar substrate panel, the dimensions of which correspond to the dimensions of the substantially horizontal surface to be decorated. This particular embodiment of the invention is depicted by arrows 234 which bypass the steps 216 and 218.

In a further aspect of the invention, a particular section of the image is printed onto a particular flexible laminar substrate panel to which it corresponds in terms of orientation, shape, dimension and the position on the surface to be decorated 220. In an aspect of the invention the flexible laminar substrate panels with a portion of the image printed thereon is covered with an adhesive at least on one side of the panel 224. In a further aspect of the invention the flexible laminar substrate panel with the graphic design thereon is covered with a graphic protection layer 228.

A further aspect of the invention provides affixing a particular flexible laminar substrate panel with a portion of the image printed thereon to the corresponding section of the substantially flat surface to be decorated to which it corresponds in terms of shape, orientation, dimension and position on the surface to be decorated 232.

It is within the scope of the abilities of a skilled artisan that the step 224 of impregnating at least one side of the flexible laminar substrate panel with an adhesive may be performed prior to the steps of analyzing the surface to be decorated 212, preparing the flexible laminar substrate panels 216, printing the image on the flexible laminar substrate panels 220, covering the printed surface of the flexible laminar substrate panel with a graphic protection tool 228, or affixing the plurality of flexible laminar substrate panels to the surface to be decorated 232.

Further, it is also within the scope of a skilled artisan that the step 216 of preparing the plurality of flexible laminar substrate panels wherein the number, orientation, shapes and dimensions of the flexible laminar substrate panels correspond to the number, orientation, shapes and dimensions of the plurality of sections of the surface to be decorated may be performed prior to the step of impregnating the panels with adhesive 224, covering the printed surface with the graphic design protection material 228, or affixing the panels onto the surface to be decorated 232. Dotted arrows 222, 226, and 230 represent these aspects of the current invention.

In an aspect of the invention, the substantially flat surface to be decorated has gaps in-between the adjacent sections. An aspect of the invention provides flexible laminar substrate panels that prevent the gaps in-between the sections from disturbing the appearance of the image displayed thereon.

FIG. 4A depicts an aspect of the invention, wherein, sections 310b and 312b of the substantially flat surface to be decorated have gaps 314b in-between. In an aspect of the invention, the portions of image 314a corresponding to gap 341b in-between the sections of the surface to be decorated are directly printed or painted 316 onto the gaps in-between the sections of the surface to be decorated, wherein, affixing laminar substrate panels 310c and 312c with a portion of the image printed thereon produces an image which is continuous with the portion of the image printed or painted onto gap 314b.

In a further aspect of the invention, the portions of the image corresponding to gap 314a are printed onto flexible laminar substrate panel 314c which has the dimensions corresponding to the dimensions of the gaps in-between the sections, for example, preparing long and narrow flexible laminar substrate panels 314c. The flexible laminar substrate panel corresponding to the gap in-between the sections is affixed onto the gap in-between the sections of the surface to be decorated whereby the appearance of the image displayed on the surface is not disturbed by the gap in-between the sections.

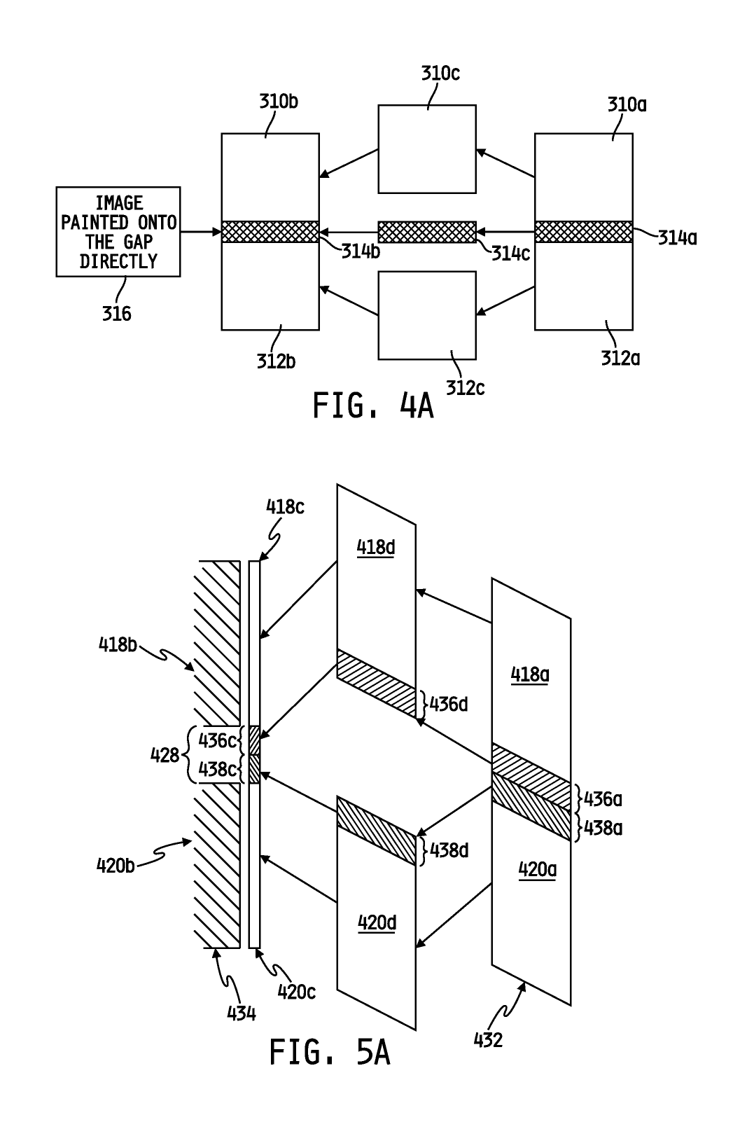

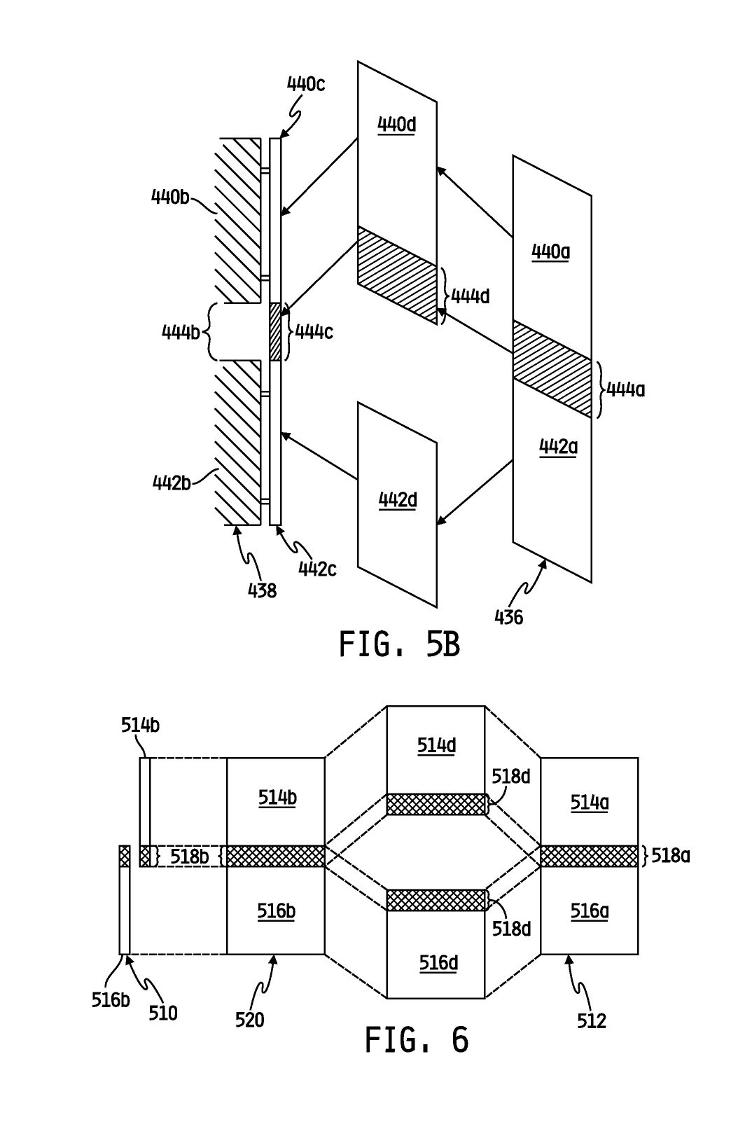

FIGS. 5A and 5B depict an aspect of the invention wherein the gaps in-between the sections are covered by extensions from one or more of the sections adjacent to the gap, and the extensions cover the gaps without affecting the mobility of the sections relative to each other. FIG. 5A represents a partial side view of surface 434 comprising a plurality of sections. Specifically, sections 418b and 420b represent two adjacent sections from the plurality of sections and protection material 428 represents the gap in-between the sections. Further, sections 418c and 420c represent the covering on adjacent sections 418b and 420b, respectively. Coverings 318c and 320c comprise extensions 436c and 438c respectively, which cover gap 428 between adjacent sections. Image 432 is divided in plurality of sections 418a and 420a that correspond to coverings 318c and 320c instead of corresponding to sections 418b and 420b. Sections 418a and 420a contain portions 436a and 438a respectively which further correspond to portions 436c and 438c respectively. Flexible laminar substrates 418d and 420d have portions 418a and 420a of image 432 printed thereon. Flexible laminar substrates 418d and 420d also contain portions 436d and 438d respectively which further correspond to portions 436c and 438c and coverings 418c and 420c.

FIG. 5B depicts an embodiment of the current invention wherein 440b and 442b represent two adjacent sections from the plurality of sections and 444b represents the gap in-between. Further, embodiments 440c and 442c represent the coverings on adjacent sections 440b and 442b, respectively. Covering 440c comprises extensions 444c, which entirely covers gap 444b between adjacent sections. Because covering 442c does not contain any extensions, the dimensions of covering 442c are identical to the dimensions of section 442b. Image 436 is divided in plurality of sections 440a and 442a that correspond to coverings 440c and 442c, respectively. Further, section 440a contains portion 444c which correspond to section 444d of flexible laminar substrate panel 440d, and to portion 444c of covering 440c.

In a further embodiment of the invention, for example, as shown in FIG. 6, a substantially horizontal substrate comprises of two or more adjacent sections 514b and 516b, which have extensions, wherein, extensions 518b from one or more sections overlap with the extensions from the other sections. In an embodiment of the invention, when the extensions from adjacent sections overlap with each other, image 512 which is displayed on the surface may be divided into a plurality of sections 514a and 516a wherein different sections contain a portion of image 518a which is common between the two adjacent sections of the image.

FIG. 6 represents side sectional view 510 and front view 520 of adjacent sections 514b and 516b of a substantially flat surface to be decorated wherein 518b represents an overlapping portion between adjacent sections. Image 512 is divided into a plurality of sections 514a and 516a having a portion of image 518a overlapping between the two adjacent sections which facilitates decorating a surface comprised of sections that overlap with adjacent sections.

Section 514a is printed on flexible laminar substrate panel 514d, whereas portion 516a is printed on flexible laminar substrate panel 516d. Flexible laminar substrate panels 514d and 516d are affixed onto panels 514b and 516b respectively. Flexible laminar substrate panels 514d and 516d contain portion 518d which is common between the two panels.

In a further aspect of the invention the image to be displayed is be divided into plurality of sections wherein the sections differ from each other in dimensions, for example, all the sections may have different width or length from each other. Even further, the image may be divided into sections of various geometrical shapes and sizes, depending upon the shapes and sizes of the section constituting the surface to be decorated.

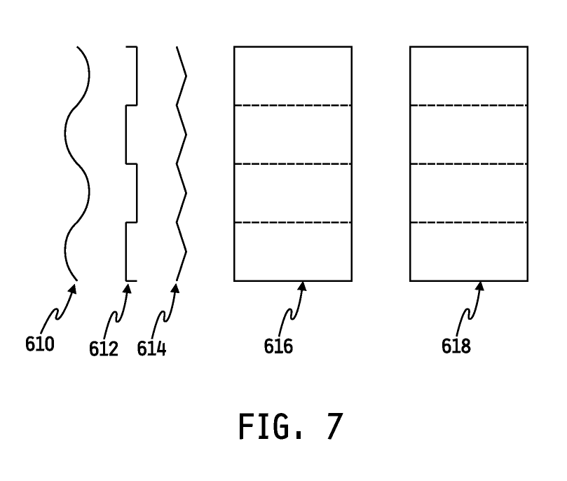

FIG. 7 represents an aspect of the invention wherein the substantially flat surface is slightly uneven. In aspect of the invention the surface to be decorated is corrugated 610, or notched 612, or zigzag 614. In another aspect of the invention, the substantially flat surface is partially or completely convex 616 or concave 618 on the outside. In a further aspect of the invention, the flexible laminar substrate panels are designed to adjust to corrugations, zigzags, convexity and concavity of the surface to be decorated, which facilitates affixing the flexible laminar substrate panels onto the surface.

In an embodiment of the invention, Sophisticate, Patrician and Aristocrat series garage doors manufactured by Safe-Way Door, LLC, Warsaw, Ind., USA are decorated by the flexible laminar substrate panels as specified in the present disclosure. A skilled artisan may readily envision, that other types of doors may be decorated using the flexible laminar substrate disclosed herein.

In a further aspect of the invention, the sectional overhead garage door is comprised of a metal or metal alloy. In an aspect of the invention, the sectional overhead garage door is comprised of flush steel. In a further aspect of the invention the garage door may be insulated or un-insulated. In a further aspect of the invention, the garage door is coated with a galvanizing layer. In an even further aspect of the invention, the garage door is coated with a primer coat. In an even further aspect of the invention, the garage door is coated with a finish paint coat.

In an embodiment of the invention, sections of the image are screen printed onto the flexible laminar substrate panels to produce “life-like” appearance to the image produced on the surface to be decorated. Screen printing techniques provide realistic appearance to the image produced on the garage door when the flexible laminar substrate panels are affixed onto the sections of the garage door. In a particular embodiment of the invention, the ink used for screen printing the image is 3M™ Screen Printing Ink Series 1900 line color and four color, 3M™ Screen Printing US Ink Series 9800 line color and four color, Sericol™ Duracal™ US Screen Print Ink or Sericol™ Duracal™ Screen Print clear; all of which are manufactured by “3M Graphics,” St. Paul, Minn., USA.

In an embodiment of the invention, flexible laminar substrate is comprised of a flexible polymeric material, for example, vinyl polymer. In a particular embodiment of the invention, the flexible laminar substrate comprises of Controlac™ Graphic Film Series 180, Controlac™ Graphic Film with Comply™ adhesive or Comply™ v2 adhesive, all of which are manufactured by the “3M Graphics,” St. Paul, Minn., USA. In an additional embodiment of the invention, the Controlac™ Graphic Film used is transparent or opaque. In an additional embodiment of the invention, the Controlac™ Graphic Film used is colored.

In an embodiment of the invention, a graphic protection layer is applied over the printed surface of the flexible laminar substrate. Graphic protection improves appearance, performance and durability of the flexible laminar substrate panels. In an embodiment of the invention, the graphic protection layer is 3M™ Screen Print Gloss Clear 1920DR, 3M™ Screen Printing Low Gloss Clear 1930, 3M™ Screen Print US Gloss Clear 9720i, 3M™ Screen Print Clear 1920US, or 3M™ Screen Printing Gloss Clear 9700CL; all of which are manufactured by “3M Graphics,” St. Paul, Minn., USA.

Other materials may be used in further embodiments of the invention. Conventional ultraviolet (UV) inks employed in appliqués for garage door laminates rely chiefly on high gloss or coated vinyl stock finish. The appearance of these appliqués leads to a ‘plastic’ or ‘fake’ look about the doors. This is a disadvantage especially if the desired effect is to exhibit wood or metallic based depictions in the laminate. Matting agents in to remove gloss in standard UV coating and inks primarily rely on fumed and refined silicas. The disadvantage of these materials is their hygroscopic nature and potential for ‘clumping’. This results in an ‘overspray’ or painted effect which looks, upon close inspection, to appear as an excess amount of coating (wetted) has by applied on the surface. To matte the coating properly and avoid the problems of hygroscopic silicas, functionalized (including but not limited to tri-methyl silane, or TMS) amorphous silicas or sol gel may be applied within the coating ink matrix to achieve the desired matting effect while being inherently hydrophobic. The use of the sol gels may also add to the life of the laminate and garage door by giving an anti-corrosion effect, or hydrophobicity.

A skilled artisan may easily envision from the exemplary description of the invention that the embodiments described herein may be used in a number of applications in addition to decorating a sectional overhead garage door. Further, modifications may be made to the embodiments disclosed herein to use the invention in a number of additional uses.

What is claimed is:

1. A sectional overhead garage door comprising,
a plurality of sections, and
a plurality of flexible laminar substrate panels with graphic design thereon affixed onto the plurality of sections.

2. The sectional overhead garage door of claim 1, wherein
the flexible laminar substrate panels are comprised of a synthetic polymeric material.

3. The sectional overhead garage door of claim 2, wherein
the synthetic polymeric material is vinyl.

4. The sectional overhead garage door of claim 3, wherein
the flexible laminar substrate panel is 1-5 mil thick.

5. The sectional overhead garage door of claim 4, wherein
an image is screen printed on the flexible laminar substrate panels.

6. The sectional overhead garage door of claim 5, wherein
the image screen printed onto the flexible laminar substrate panel is a portion of a picture depicting an object or a scenery.

7. The sectional overhead garage door of claim 6, wherein
the picture depicts a carriage house design.

8. The sectional overhead garage door of claim 7, wherein
the picture depicts a carriage house having windows thereon.

9. The sectional overhead garage door of claim 6, wherein
the screen printed image is covered by a protection material.

10. A kit comprising,
a plurality of flexible laminar substrate panels with a portion of a graphic design thereon, wherein, upon affixing the plurality of the panels onto a substantially flat surface comprised of a plurality of sections, an image of an object or a scene is produced on the surface.

11. The kit of claim 10, wherein
the flexible laminar substrate panels are comprised of a synthetic polymeric material.

12. The kit of claim 10, wherein
the synthetic polymeric material is vinyl.

13. The kit of claim 10, wherein
the flexible laminar substrate panel is 1-5 mil thick.

14. The kit of claim 10, wherein
an image is screen printed on the flexible laminar substrate panels.

15. The kit of claim 14, wherein
the image screen printed onto the flexible laminar substrate panel is a portion of a picture depicting an object or a scenery.

16. The kit of claim 15, wherein
the picture depicts a carriage house.

17. The kit of claim 16, wherein
the picture depicts a carriage house having windows.

18. The kit of claim 16, wherein
the picture is specifically selected.

19. The kit of claim 14, wherein
the screen printed image is covered by a protection material.

20. A method of decorating a sectional overhead garage door comprising,
affixing the plurality of the flexible laminar substrate panels of claim 10 onto a plurality of horizontal sections of a garage door.

21. A method of decorating a sectional overhead garage door comprising steps of,
providing a flexible laminar substrate panel
printing a graphic design thereon
affixing the flexible laminar substrate panel with the graphic design thereon to a substantially flat surface.

22. A method of manufacturing a kit comprising,
analyzing a surface to be decorated,
preparing a plurality of flexible laminar substrate panels which correspond to the surface to be decorated,
selecting an image,
manipulating the image to correspond to the plurality of flexible laminar substrate panels and the surface to be decorated, and,
printing the manipulated image on the plurality of flexible laminar substrate panels.
